(19) United States
(12) Patent Application Publication
(10) Pub. No.: US 2023/0011569 A1
(43) Pub. Date: Jan. 12, 2023

(54) METHOD AND APPARATUS FOR DETECTING DEFECT, DEVICE, AND STORAGE MEDIUM

(71) Applicant: CHANGXIN MEMORY TECHNOLOGIES, INC., Hefei City (CN)

(72) Inventor: CHEN-HAO CHEN, Hefei (CN)

(21) Appl. No.: 17/842,083

(22) Filed: Jun. 16, 2022

Related U.S. Application Data
(63) Continuation of application No. PCT/CN2021/122564, filed on Oct. 8, 2021.

(30) Foreign Application Priority Data
Jul. 9, 2021 (CN) 202110777266.7

(51) Int. Cl. G06T 7/00; G06T 7/13; G06T 7/73; G06V 10/44; G06V 10/22; G06T 7/11; G06F 16/53; G06F 16/58; G01N 21/95

(52) U.S. Cl. CPC G06T 7/0004; G06T 7/13; G06T 7/73; G06V 10/44; G06V 10/22; G06T 7/11; G06F 16/53; G06F 16/5866; G01N 21/9503; G06T 2207/20021; G06T 2207/30148

(57) ABSTRACT

A method for detecting a defect includes: a measurement image including a wafer edge of a wafer to be detected is acquired; an image region to be detected is determined in the measurement image; feature extraction is performed on the image region to be detected to obtain a pixel distribution characteristic of the image region to be detected; and defect detection is performed on the wafer edge based on the pixel distribution characteristic of the image region to be detected.

### CROSS-REFERENCE TO RELATED APPLICATIONS

This application is a continuation of International Application No. PCT/CN2021/122564, filed on Oct. 8, 2021, which claims priority to Chinese Patent Application No. 202110777266.7, filed on Jul. 9, 2021. The disclosures of International Application No. PCT/CN2021/122564 and Chinese Patent Application No. 202110777266.7 are hereby incorporated by reference in their entireties.

### BACKGROUND

In a manufacturing process of a semiconductor component, a defect at the edge of the wafer (i.e., the wafer edge) has a great effect on the process steps and the product yield. In the related art, an image of a wafer edge captured by a measuring machine after a process treatment (e.g., after a photolithography process, after an etching process) is usually used as a measurement image, and manual observation is performed based on the captured measurement image to determine whether the wafer edge has a defect. However, if the defect detection is performed by manual observation, there is a problem of high labor cost, and the defect is easy to be missed or falsely detected. In addition, in the manner of manual observation, a feedback regarding the accuracy of the defect judgment cannot be obtained until the yield test stage, which usually results in a delay of 2 weeks, so that the defects are not discovered in time.

### SUMMARY

The embodiments of the present disclosure relate to, but are not limited to, the semiconductor field, and in particular to a method and an apparatus for detecting a defect, a device, and a storage medium.

In view of the above, the embodiments of the present disclosure provide a method and an apparatus for detecting a defect, a device, and a storage medium.

The technical solutions in the embodiments of the present disclosure are realized as follows.

In one aspect, the embodiments of the present disclosure provide a method for detecting a defect. The method includes the following operations. A measurement image including a wafer edge of a wafer to be detected is acquired. An image region to be detected is determined in the measurement image. Feature extraction is performed on the image region to be detected to obtain a pixel distribution characteristic of the image region to be detected. Defect detection is performed on the wafer edge based on the pixel distribution characteristic of the image region to be detected.

In another aspect, the embodiments of the present disclosure provide an apparatus for detecting a defect, which includes a processor and a memory storing processor-executable instructions. The processor is configured to execute the stored processor-executable instructions to perform operations of: acquiring a measurement image comprising a wafer edge of a wafer to be detected; determining an image region to be detected in the measurement image; performing feature extraction on the image region to be detected to obtain a pixel distribution characteristic of the image region to be detected; and performing defect detection on the wafer edge based on the pixel distribution characteristic of the image region to be detected.

In still another aspect, the embodiments of the present disclosure provide a non-transitory computer-readable storage medium storing a program that, when executed by a processor, causes the processor to implement operations of: acquiring a measurement image comprising a wafer edge of a wafer to be detected; determining an image region to be detected in the measurement image; performing feature extraction on the image region to be detected to obtain a pixel distribution characteristic of the image region to be detected; and performing defect detection on the wafer edge based on the pixel distribution characteristic of the image region to be detected.

### BRIEF DESCRIPTION OF THE DRAWINGS

FIG. 1 illustrates a schematic flowchart of a method for detecting a defect according to an embodiment of the present disclosure.

FIG. 2 illustrates a schematic flowchart of a method for detecting a defect according to an embodiment of the present disclosure.

FIG. 3 illustrates a schematic flowchart of a method for detecting a defect according to an embodiment of the present disclosure.

FIG. 4 illustrates a schematic flowchart of a method for detecting a defect according to an embodiment of the present disclosure.

FIG. 5 illustrates a schematic flowchart of a method for detecting a defect according to an embodiment of the present disclosure.

FIG. 6A illustrates a schematic diagram of an image region to be detected in a measurement image according to an embodiment of the present disclosure.

FIG. 6B illustrates a schematic diagram of a change curve of a proportion of white pixels in an image region within different height ranges in a sub-image having a defect among a region corresponding to different angles according to a method for detecting a defect according to an embodiment of the present disclosure.

FIG. 6C illustrates a schematic diagram of comparison between an image region having a wafer edge defect and an image region having no wafer edge defect according to a method for detecting a defect according to an embodiment of the present disclosure.

FIG. 6D illustrates a schematic diagram of a change curve of a proportion of white pixels in an image region to be detected in a sub-image having a defect among a region corresponding to different angles according to a method for detecting a defect according to an embodiment of the present disclosure.

FIG. 7 illustrates a schematic diagram of a composition of an apparatus for detecting a defect according to an embodiment of the present disclosure.

FIG. 8 illustrates a schematic diagram of a hardware entity of a computer device according to an embodiment of the present disclosure.

### DETAILED DESCRIPTION

In order to make the objectives, technical solutions and advantages of the present disclosure clearer, the technical solutions in the present disclosure are described in further detail below with reference to the accompanying drawings and embodiments. The described embodiments shall not be regarded as limiting the present disclosure, and all other embodiments obtained by those skilled in the art without creative effort shall be fallen within the protection scope of the present disclosure.

In the following description, “some embodiments” are referred to, which describe a subset of all possible embodiments, but it is understood that “some embodiments” may be the same subset or different subsets of all possible embodiments, and may be combined with each other without conflict.

If a similar description of “first/second” appears in the disclosure, the following description shall be added. In the following description, the terms “first/second/third” involved only distinguish similar objects and do not mean a specific ordering with regard to objects, it can be appreciated that “first/second/third” may be interchanged in a specific order or precedence if permitted, so that the embodiments of the present disclosure described herein may be implemented in an order other than those illustrated or described herein.

Unless otherwise defined, all technical and scientific terms used herein have the same meaning as commonly understood by those skilled in the technical field of the present disclosure. The terms used herein is only for the purpose of describing the present disclosure, and is not intended to limit the present disclosure.

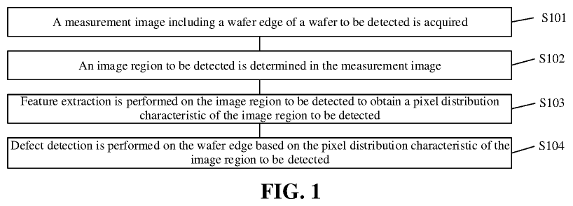

The embodiments of the present disclosure provide a method for detecting a defect, which may be performed by a processor of a computer device. A computer device may refer to any appropriate device with data processing capabilities, such as a server, a laptop, a tablet computer, a desktop computer, a smart TV, a set-top box, a mobile device (such as a mobile phone, a portable video player, a personal digital assistant, a special messaging device, a portable game device). FIG. 1 illustrates a schematic flowchart of a method for detecting a defect according to an embodiment of the present disclosure. As illustrated in FIG. 1, the method includes the operations S101 to S104.

In S101, a measurement image including a wafer edge of a wafer to be detected is acquired.

Herein, the wafer edge of the wafer to be detected refers to the edge of the wafer to be detected, and includes a side surface region of the wafer, a region where the side surface of the wafer is adjacent to the upper surface, and a region where the side surface of the wafer is adjacent to the lower surface.

The measurement image is an image including a wafer edge and acquired during process treatment on the wafer to be detected. In an implementation, a measurement image including a wafer edge may be obtained by photographing the edge of the wafer to be detected by the image acquisition device during process treatment on the wafer. The image acquisition device may be mounted at any suitable location of the machine, which is not limited herein.

In some embodiments, the measurement image includes a wafer edge of the wafer to be detected, a partial region adjacent to the wafer edge on the upper surface of the wafer to be detected, and a partial region adjacent to the wafer edge on the lower surface of the wafer to be detected.

In S102, an image region to be detected is determined in the measurement image.

Herein, the image region to be detected is an image region with a prominent wafer edge defect feature in the measurement image, and the defect of the wafer edge may be detected more accurately in the image region, thereby improving the accuracy of the wafer edge defect detection.

In an implementation, the image region to be detected is determined from the measurement image according to a preset location information, the image region to be detected is determined in the measurement image based on the location of the image region with a prominent wafer edge defect feature in the historical measurement image, or the image region to be detected is automatically recognized in the measurement image by using the trained neural network model. Those skilled in the art determine an image region to be detected in the measurement image in any suitable manner according to actual conditions, which is not limited in the embodiments of the present disclosure.

In S103, feature extraction is performed on the image region to be detected to obtain a pixel distribution characteristic of the image region to be detected.

Herein, the pixel distribution characteristic of the image region to be detected includes any suitable features that reflect the distribution of different pixels in the image region to be detected.

In some embodiments, after digitalization processing is performed on the image region to be detected, the distribution of pixels with different values in the image region to be detected may be counted to obtain the pixel distribution characteristic of the image region to be detected. Herein, the pixel distribution characteristic in the image region to be detected includes, but is not limited to, one or more of a total number of pixels corresponding to at least one value in the image region to be detected, a proportion of pixels corresponding to at least one value in the image region to be detected, or a distribution state of pixels corresponding to at least one value at different locations in the image region to be detected. For example, after the image region to be detected is subjected to binarization processing, the distribution of the black and white pixels in the image region to be detected subjected to the binarization processing may be counted to obtain the total number of the black pixels or white pixels in the image region to be detected, the difference between the number of the black pixels and the number of the white pixels, the ratio of the number of the black pixels to the number of the white pixels, the proportion of the black pixels or the white pixels, the distribution of the black pixels or white pixels at different locations in the image region to be detected, and the like.

In S104, defect detection is performed on the wafer edge based on the pixel distribution characteristic of the image region to be detected.

Herein, compared to a case where the wafer edge has no defect, the distribution of pixels in the image region to be detected changes in a case where the wafer edge has a defect. Therefore, it is possible to detect whether or not the image region to be detected has a defect, the distribution of defects, or the like according to the pixel distribution characteristic of the image region to be detected.

In the implementation, the pixel distribution characteristic of the image region to be detected is matched with the preset pixel distribution characteristic representing that the image region has no defects to determine whether the wafer edge has a defect; the pixel distribution characteristic of the image region to be detected is matched with the preset pixel distribution characteristic representing that the image region has a defect to determine whether the wafer edge has a defect; the pixel distribution characteristic of the image region to be detected is matched with the preset pixel distribution characteristic representing that the image region has a particular type of defect to determine whether the wafer edge has the particular type of defect. Those skilled in the art may perform defect detection on a wafer edge in an appropriate manner according to pixel distribution characteristic of an image region to be detected according to an actual situation, which is not limited in the embodiments of the present disclosure.

In some embodiments, the above operation S102 may include operation S111.

In S111, the image region to be detected is determined in the measurement image based on a preset feature.

Herein, the preset feature may be any suitable feature that may be used for recognizing the image region with a prominent wafer edge defect feature. In an implementation, the preset feature may include, but are not limited to, one or more of a preset location range, a pixel distribution characteristic, a wafer edge feature, and the like. For example, in the case where the preset feature includes a preset location range, an image region corresponding to the location range in the measurement image may be determined as an image region to be detected. For another example, in the case where the preset feature includes a preset pixel distribution characteristic, an image region including the pixel distribution characteristic in the measurement image may be determined as an image region to be detected.

In some embodiments, the method may further include operation S121.

In S121, warning information is generated and transmitted in a case where it is determined that the wafer edge has a defect.

Herein, the warning information is information for warning that the wafer edge of the wafer to be detected has a defect, and may include but is not limited to one or more of voice warning information, warning indicator information, warning telephone, warning mail, instant communication software information, and the like, and is not limited herein. The user may perform an appropriate warning response according to the warning information. For example, the user may stop the operation of the related process chamber after the warning information is received, locate the cause of the defect, maintain the device, or the like.

In some embodiments, the method may further include the operations S131 to S132.

In S131, a process chamber corresponding to the measurement image is determined.

Herein, the process treatment on the wafer is usually performed in at least one process chamber, and different process treatment steps are performed in different process chambers, so that the measurement images acquired in different process treatment steps of the wafer also correspond to different process chambers. In an implementation, when the measurement images are acquired, the measurement images may correspond to respective process chambers, so that the process chamber corresponding to the measurement image may be determined according to the measurement image.

In S132, the operation of the machine in the process chamber is stopped in a case where it is determined that the wafer edge has a defect.

In some embodiments, the method may further include the operations S141 to S142.

In S141, a time range to be queried and a process chamber are acquired in response to a data query operation acting on a wafer edge anomaly trend query interface.

Herein, the wafer edge anomaly trend query interface may be any suitable interface for querying a trend of anomalies of the wafer edge operating on the terminal device. The user may perform a data query operation at the wafer edge anomaly trend query interface.

The time range to be queried and the process chamber may be preset, or may be input by the user through the wafer edge anomaly trend query interface, which is not limited herein.

In S142, the pixel distribution characteristic of the image region to be detected in each measurement image acquired within the time range and corresponding to the process chamber is queried.

Herein, after the pixel distribution characteristic of the image region to be detected in each measurement image is acquired, the acquisition time of the measurement image, the process chamber corresponding to the measurement image and the pixel distribution characteristic of the image region to be detected in the measurement image may be stored in association. Based on the time range to be queried and the process chamber, the pixel distribution characteristic of the image region to be detected in each measurement image acquired within the time range and corresponding to the process chamber may be queried.

In S143, the pixel distribution characteristic of the image region to be detected in each e measurement image is displayed in the wafer edge anomaly trend query interface.

Herein, the pixel distribution characteristic of the image region to be detected in the measurement image may be displayed in any suitable manner in the wafer edge anomaly trend query interface according to the actual situation. For example, the pixel distribution characteristic of the image region to be detected in each measurement image may be displayed in the form of a data table, a trend graph, a bar graph, or the like.

By displaying the pixel distribution characteristic of the image region to be detected in each measurement image acquired within the time range to be queried and corresponding to the process chamber to be queried in the wafer edge anomaly trend query interface, the pixel distribution characteristic of the image region to be detected in the measurement images in different process processes may be visually observed, and furthermore, the risk of defects occurring on wafer edges in different process treatment steps may be intuitively judged or referenced.

In the embodiments of the present disclosure, firstly, a measurement image including a wafer edge of a wafer to be detected is acquired; secondly, an image region to be detected is determined in the measurement image; and then, feature extraction is performed on the image region to be detected to obtain a pixel distribution characteristic of the image region to be detected; finally, defect detection is performed on the wafer edge based on the pixel distribution characteristic of the image region to be detected. In such a way, the labor cost may be reduced, the missing detection or false detection may be reduced, and the defect at the wafer edge of the wafer to be detected may be discovered in time. Furthermore, since the defect detection of the wafer edge is performed based on the pixel distribution characteristic of the image region to be detected, and the image region to be detected is determined in the measurement image of the wafer edge of the wafer to be detected, and therefore, the efficiency of the defect detection may be effectively improved.

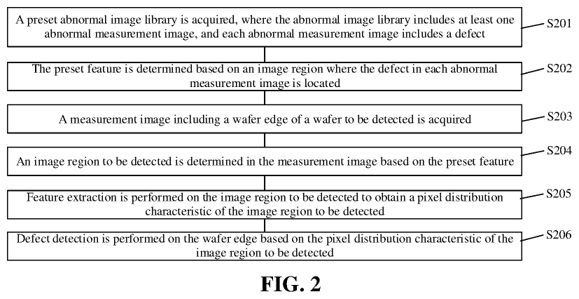

The embodiments of the present disclosure provide a method for detecting a defect, which may be performed by a processor of a computer device. As illustrated in FIG. 2, the method includes operations S201 to S206.

In S201, a preset abnormal image library is acquired, the abnormal image library includes at least one abnormal measurement image, and each abnormal measurement image includes a defect.

Herein, each abnormal measurement image in the abnormal image library may include at least one defect. The abnormal image library may be determined in advance according to historical measured images, may be acquired from the Internet, or may be automatically generated by using image processing techniques. In an implementation, those skilled in the art may acquire a preset abnormal image library in an appropriate manner according to actual needs, which is not limited in the embodiments of the present disclosure.

In S202, the preset feature is determined based on an image region where the defect in each abnormal measurement image is located.

Herein, any suitable feature in the image region where the defect in each abnormal measurement image is located may be extracted as a preset feature. In an implementation, the location information of the image region where the defect in each abnormal measurement image is located may be analyzed, and the obtained location feature may be taken as a preset feature; the pixel distribution of the image region where the defect in each abnormal measurement image is located may be analyzed, and the obtained pixel distribution characteristic may be taken as a preset feature; the image feature of the image region where the defect in each abnormal measurement image is located may be analyzed, and the obtained image feature may be taken as a preset feature.

In S203, a measurement image including a wafer edge of a wafer to be detected is acquired.

In S204, an image region to be detected is determined in the measurement image based on the preset feature.

In S205, feature extraction is performed on the image region to be detected to obtain a pixel distribution characteristic of the image region to be detected; and

In S206, defect detection is performed on the wafer edge based on the pixel distribution characteristic of the image region to be detected.

Herein, S203 to S206 correspond to the above S101, S111, S103 and S104, and reference may be made to the specific implementations of the above S101, S111, S103 and S104.

It should be noted that the above S201 to S206 are not limited to the performing order illustrated in FIG. 2. For example, S201 and S202 may be performed after S203.

In some embodiments, the preset feature includes a preset location range in a longitudinal dimension, and the above S202 may include the operations S211 to S212.

In S211, a location of the image region where the defect in each abnormal measurement image is located in the longitudinal dimension of the each abnormal measurement image is determined.

Herein, the longitudinal dimension is a direction dimension corresponding to the measurement direction of the wafer thickness in the measurement image or the abnormal measurement image.

In S212, the preset location range in the longitudinal dimension is determined based on a determined location of the image region where the defect in each abnormal measurement image is located.

Herein, the preset location range in the longitudinal dimension is a location range where there is a high probability of detecting wafer edge defects in the longitudinal dimension of the measurement image. In an implementation, the location of the image region where each defect is located in the longitudinal dimension of the each abnormal measurement image may be analyzed, the distribution of defects in different locations in the longitudinal dimension may be determined, and then the preset location range in the longitudinal dimension may be determined. For example, a location range having the largest number of defects in the longitudinal dimension may be determined as a preset location range in the longitudinal dimension, or a location range having the largest distribution density of defects in the longitudinal dimension may be determined as a preset location range in the longitudinal dimension.

In some embodiments, the preset feature includes a first preset pixel distribution characteristic in a transversal dimension, and the above S202 may include the operations S221 to S223.

In S221, a first image region set is determined based on the image region where the defect in each abnormal measurement image is located, each image region of the first image region set includes at least one defect.

Herein, the first image region set may include the image region where the defect in each abnormal measurement image is located.

In S222, a pixel distribution characteristic of each image region of the first image region set in the transversal dimension is determined.

Herein, the transversal dimension is a direction dimension perpendicular to the longitudinal dimension of the measurement image. The pixel distribution characteristic of the image region in the transversal dimension may include, but are not limited to, one or more of a number of pixels corresponding to at least one value in the image region subjected to the digitalization processing at different locations in the transversal dimension, a proportion of pixels corresponding to at least one value at different locations in the transversal dimension in the image region, or a distribution state of pixels corresponding to at least one value at different locations in the transversal dimension in the image region.

In an implementation, after the image region is subjected to the digitalization processing, the distribution of pixels of different values in the image region subjected to the digitalization processing in the transversal dimension is analyzed to obtain the pixel distribution characteristic of the image region in the transversal dimension. For example, after the image region is subjected to the binarization processing, the distribution of the black and white pixels in the image region subjected to the binarization processing in the transversal dimension may be counted to obtain the total number of the black pixels or white pixels in the image region, the difference between the number of the black pixels and the number of the white pixels, the ratio of the number of the black pixels to the number of the white pixels, the proportion of the black pixels or the white pixels, the distribution of the black pixels or white pixels at different locations in the transversal dimension in the image region, and the like.

In S223, the first preset pixel distribution characteristic is determined based on the pixel distribution characteristic of each image region in a transversal dimension.

Herein, the first preset pixel distribution characteristic is a pixel distribution characteristic of an image region with a prominent wafer edge defect feature in the measurement image in the transversal dimension. In an implementation, any suitable feature extraction method may be adopted to extract the first preset pixel distribution characteristic from the pixel distribution characteristic of each image region in the transversal dimension, or the pixel distribution characteristic of each image region in the transversal dimension may be statistically analyzed to obtain the first preset pixel distribution characteristic, which is not limited herein.

In some embodiments, the above S221 may include operations S2211 and S2212. In S2211, each abnormal measurement image is segmented in a longitudinal dimension to obtain a second image region set; and in S2212, an image region including at least one defect is selected from the second image region set, based on the image region where the defect in each abnormal measurement image is located, to obtain the first image region set. Herein, each image region of the second image region set corresponds to a different location range in the longitudinal dimension. In some implementations, each abnormal measurement image may be segmented equally in the longitudinal dimension to obtain a second image region set.

In some embodiments, the above S204 may include operations S231 to S232.

In S231, the measurement image of the wafer edge of the wafer to be detected is segmented in a longitudinal dimension to obtain a third image region set.

In S232, the image region to be detected is determined from the third image region set based the first preset pixel distribution characteristic.

Herein, the image region matching the first preset pixel distribution characteristic of the third image region set may be determined as the image region to be detected.

In some embodiments, the preset feature includes a preset wafer edge feature, the image region to be detected includes an image region including the preset wafer edge feature, and above S204 may include operation S241. In S241, feature recognition is performed on the measurement image to obtain an image region including the preset wafer edge feature. Herein, the preset wafer edge feature may be any suitable preset feature for recognizing a wafer edge, which is not limited herein. In an implementation, any suitable image recognition technique may be used for performing feature recognition on the measurement image to obtain an image region including a preset wafer edge feature.

In the embodiments of the present disclosure, a preset feature is determined based on the image region where the defect in each abnormal measurement image in the preset abnormal image library is located, and an image region to be detected is determined in the measurement image based on the preset feature. In this way, the preset feature may be acquired quickly and accurately, so that the image region to be detected with a prominent wafer edge defect feature may be accurately determined in the measurement image, and the accuracy of defect detection on the wafer edge may be further improved.

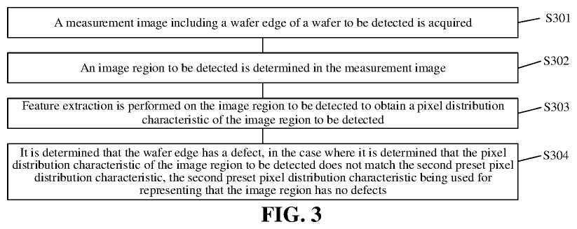

The embodiments of the present disclosure provide a method for detecting a defect, which may be performed by a processor of a computer device. As illustrated in FIG. 3, the method includes the operations S301 to S304.

In S301, a measurement image including a wafer edge of a wafer to be detected is acquired.

In S302, an image region to be detected is determined in the measurement image.

In S303, feature extraction is performed on the image region to be detected to obtain a pixel distribution characteristic of the image region to be detected.

Herein, S301 to S303 correspond to S101 to S103, and reference may be made to the specific implementations of the above S101 to S103.

In S304, it is determined that the wafer edge has a defect, in the case where it is determined that the pixel distribution characteristic of the image region to be detected does not match the second preset pixel distribution characteristic, where the second preset pixel distribution characteristic is used for representing that the image region has no defects.

Herein, the second preset pixel distribution characteristic may be any suitable feature for representing that the image region has no defects, which is not limited herein. In an implementation, the second preset pixel distribution characteristic may include, but is not limited to, one or more of a total number of pixels corresponding to at least one value in an image region without a defect subjected to the digitalization processing, a proportion of pixels corresponding to at least one value in the image region, or a distribution of pixels corresponding to at least one value at different locations in the image region. For example, the distribution of black and white pixels in the image region without a defect subjected to the binarization processing may be counted to obtain the total number of black pixels or white pixels in the image region without a defect, the difference between the number of black pixels and the number of white pixels, the ratio of the number of black pixels to the number of white pixels, the proportion of black pixels or the white pixels, the distribution of black pixels or white pixels at different locations in the image region without a defect, and the like.

In some embodiments, the pixel distribution characteristic of the image region to be detected includes a distribution characteristic of black and white pixels in the image region to be detected, and the above S303 may include operations S311 to S312.

In S311, binarization processing is performed on the image region to be detected.

In S312, the distribution characteristic of the black and white pixels in the image region to be detected subjected to the binarization processing is determined.

Herein, the distribution characteristic of the black and white pixels may include, but are not limited to, one or more of the total number of black pixels or white pixels, the difference between the number of the black pixels and the number of the white pixels, the ratio of the number of the black pixels to the number of the white pixels, the ratio of the number of the white pixels to the number of the black pixels, the proportion of black pixels or white pixels, the distribution of black pixels or white pixels at different locations in the image region, and the like.

In some embodiments, the second preset pixel distribution characteristic includes a preset distribution characteristic of the black and white pixels. The above S304 may include S321. In S321, it is determined that the wafer edge has the defect, in the case where it is determined that the distribution characteristic of the black and white pixels in the image region to be detected does not match the preset distribution characteristic of the black and white pixels. Herein, the preset distribution characteristic of the black and white pixels may include, but is not limited to, one or more of a preset threshold of the total number of black pixels or white pixels, a threshold of the difference between the number of the black pixels and the number of the white pixels, a threshold of the ratio of the number of the black pixels to the number of the white pixels, a threshold of the ratio of the number of the white pixels to the number of the black pixels, a threshold of the proportion of black pixels or white pixels, a distribution of black pixels or white pixels at different locations in an image region, and the like.

In some embodiments, the distribution characteristic of the black and white pixels in the image region to be detected includes a proportion of white pixels in the image region to be detected, and the preset distribution characteristic of the black and white pixels includes a preset threshold of the proportion of the white pixels. The above S321 may include S331. In S331, it is determined that the wafer edge has a defect, in the case where it is determined that the proportion of white pixels in the image region to be detected is greater than the preset threshold of the proportion of the white pixels.

In the embodiments of the present disclosure, in the case where it is determined that the pixel distribution characteristic of the image region to be detected does not match the second preset pixel distribution characteristic representing that the image region has no defect, it is determined that the wafer edge has a defect. In this way, whether the wafer edge of the wafer to be detected has a defect may be easily and quickly determined.

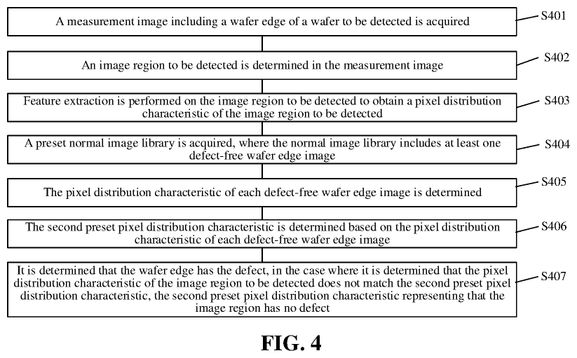

The embodiments of the present disclosure provide a method for detecting a defect, which may be performed by a processor of a computer device. As illustrated in FIG. 4, the method includes the operations S401 to S407.

In S401, a measurement image including a wafer edge of a wafer to be detected is acquired.

In S402, an image region to be detected is determined in the measurement image.

In S403, feature extraction is performed on the image region to be detected to obtain a pixel distribution characteristic of the image region to be detected.

Herein, S401 to S403 correspond to S101 to S103, and reference may be made to the specific implementations of the above S101 to S103.

In S404, a preset normal image library is acquired, the normal image library includes at least one defect-free wafer edge image.

Herein, the normal image library may be determined in advance based on the historical measurement images, may be acquired from the Internet, or may be automatically generated by using image processing techniques. In an implementation, those skilled in the art may acquire a preset normal image library in an appropriate manner according to actual needs, which is not limited in the embodiments of the present disclosure.

In S405, the pixel distribution characteristic of each defect-free wafer edge image is determined.

Herein, the pixel distribution characteristic of the defect-free wafer edge image may include, but not limited to, the pixel distribution characteristic of the defect-free wafer edge image in the transversal dimension, the pixel distribution characteristic in the longitudinal dimension, the pixel distribution characteristic in the two-dimensional coordinate system composed of the transversal dimension and the longitudinal dimension, or the like.

In S406, the second preset pixel distribution characteristic is determined based on the pixel distribution characteristic of each defect-free wafer edge image.

Herein, the second preset pixel distribution characteristic is a pixel distribution characteristic representing that the image region has no defect. In an implementation, any suitable feature extraction method may be adopted to extract the second preset pixel distribution characteristic from the pixel distribution characteristic of each defect-free wafer edge image, or the pixel distribution characteristic of each defect-free wafer edge image may be statistically analyzed to obtain the second preset pixel distribution characteristic, which is not limited herein.

In S407, it is determined that the wafer edge has the defect, in the case where it is determined that the pixel distribution characteristic of the image region to be detected does not match the second preset pixel distribution characteristic, the second preset pixel distribution characteristic represents that the image region has no defect.

Herein, S407 corresponds to the above S304, and reference may be made to the specific implementations of the above S304.

In embodiments of the present disclosure, the second preset pixel distribution characteristic is determined based on the pixel distribution characteristic in each defect-free wafer edge image of the preset normal image library. In this way, the second preset pixel distribution characteristic may be quickly and accurately acquired, thereby improving the accuracy of defect detection on the wafer edge.

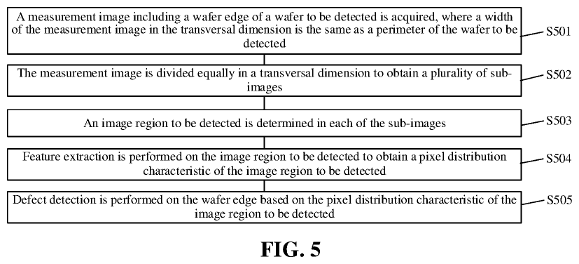

The embodiments of the present disclosure provide a method for detecting a defect, which may be performed by a processor of a computer device. As illustrated in FIG. 5, the method includes operations S501 to S505.

In S501, a measurement image including a wafer edge of a wafer to be detected is acquired, a width of the measurement image in the transversal dimension is the same as a perimeter of the wafer to be detected.

Herein, the measurement image may be an image acquired around the side surface of the wafer to be detected in one circle, and the width of the measurement image in the transversal dimension is the same as the perimeter of the wafer to be detected.

In S502, the measurement image is divided equally in a transversal dimension to obtain multiple sub-images.

Herein, in the multiple sub-images obtained by dividing the measurement image equally in the transversal dimension, each of the sub-images may correspond to a same width in the transversal dimension.

In S503, an image region to be detected is determined in each of the sub-images.

In S504, feature extraction is performed on the image region to be detected to obtain a pixel distribution characteristic of the image region to be detected.

In S505, defect detection is performed on the wafer edge based on the pixel distribution characteristic of the image region to be detected.

Herein, S503 to S505 correspond to step S102 to the above S102 to S104, and reference may be made to the specific implementations of the above S102 to S104.

In the embodiments of the present disclosure, a width of the measurement image in the transversal dimension is the same as a perimeter of the wafer to be detected, by dividing the measurement image equally in a transversal dimension to obtain multiple sub-images; and determining the image region to be detected in each of the sub-images, the measurement image may be further finely detected, so that the accuracy of defect detection on the wafer edge may be further improved.

The embodiments of the present disclosure provide a method for detecting a defect, which includes operations S601 to S605.

In S601, an image region to be detected in the measurement image including the wafer edge of the wafer to be detected is determined based on the abnormal image library.

Herein, the image region to be detected is a region with a prominent wafer edge feature in the measurement image, and corresponds to the location of the wafer edge in the measurement image. For example, the image region to be detected may be an image region, in the measurement image, within a distance of 147.5 to 147.9 nm from the bottom edge of the measurement image.

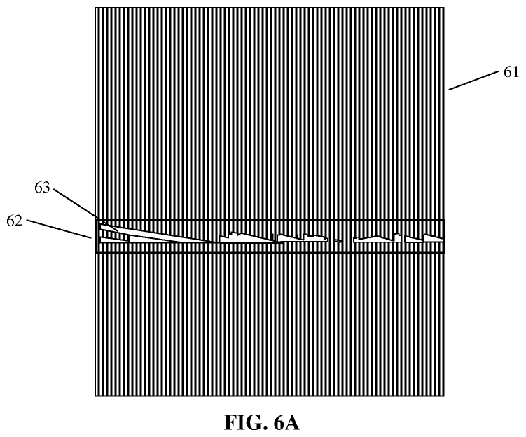

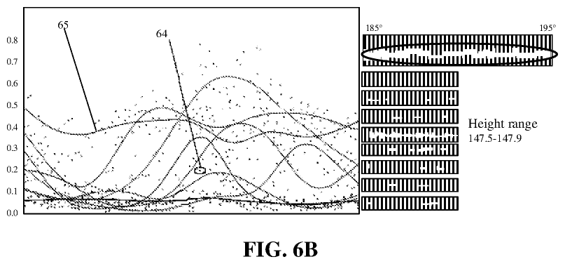

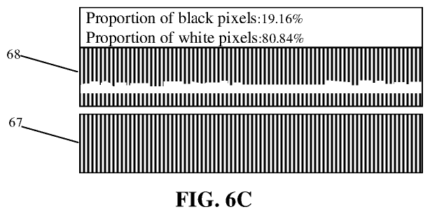

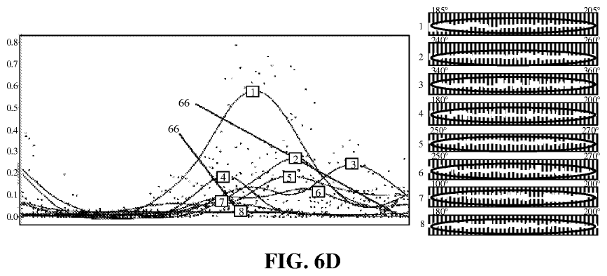

FIG. 6A illustrates a schematic diagram of an image region to be detected in a measurement image according to an embodiment of the present disclosure. As illustrated in FIG. 6A, the image region 62 to be detected is a region with a prominent wafer edge feature 63 in the measurement image 61.

In some embodiments, the image region to be detected may be implemented by operations S611 to S612.

In S611, the measurement image is segmented into X pieces in the transversal dimension to obtain X sub-images, where X is a positive integer greater than 1.

Herein, the wafer edge of the wafer to be detected includes a range of 360 degrees corresponding to the circumference of the side surface of the wafer, and each sub-image obtained after segmenting may correspond to a range of 360/X degrees of the circumference.

In S612, an image region to be detected is determined in each sub-image based on a preset location range in a longitudinal dimension.

Herein, the longitudinal dimension may be a height dimension of the measurement image, and the height of the measurement image may be a sum of a height of a wafer edge (that is, a thickness of a wafer), a height of a partial region adjacent to the wafer edge on the upper surface of the wafer, and a height of a partial region adjacent to the wafer edge on the lower surface of the wafer. For example, the height of the measurement image is 5 mm, and each sub-image is obtained after the measurement image is segmented in the transversal dimension, so the height of each sub-image is 5 mm, and the preset location range in the longitudinal dimension is a height range where the wafer edge defect feature is more prominent in the measurement image, such as the height range of 145 nm to 155 nm, or the height range of 147.5 nm to 147.9 nm.

In some embodiments, each abnormal measurement image in the abnormal image library may be segmented in the transversal dimension to obtain multiple sub-images, and each sub-image may be segmented in the longitudinal dimension to obtain multiple image regions corresponding to different location ranges in the longitudinal dimension. By analyzing the distribution of black and white pixels in the transversal dimension of each image region, the preset distribution characteristic of black and white pixels in the transversal dimension may be obtained. Based on the preset distribution characteristic of black and white pixels in the transversal dimension, the location range where the wafer edge defect feature is more prominent in the longitudinal dimension in the measurement image may be determined, that is, the preset location range in the longitudinal dimension. For example, the proportion of white pixels at different locations in the transversal dimension in each image region obtained from the abnormal image library may be analyzed, and the location range in the longitudinal dimension corresponding to an image region, of which the proportion of white pixels at different locations in the transversal dimension changes greatly or of which average proportion of the white pixels is relatively high, may be determined as the preset location range in the longitudinal dimension.

In some embodiments, the preset location range in the longitudinal dimension may be intuitively determined from the different location ranges in the longitudinal dimension according to the change curve of the proportion of the white pixels in the transversal dimension in the image region corresponding to the different location ranges in the longitudinal dimension. FIG. 6B illustrates a schematic diagram of a change curve of a proportion of white pixels in a region corresponding to different angles in image regions within different height ranges in a sub-image having a defect according to a method for detecting a defect according to an embodiment of the present disclosure. Referring to FIG. 6B, the location of the measurement image in the transversal dimension may be represented by the corresponding angle of the image region on the wafer, and the location of the measurement image in the longitudinal dimension may be represented by the height of the measurement image. The sub-image having defects whose corresponding angle range is 185 to 195 degrees is segmented in the longitudinal dimension to obtain multiple image regions, and each image region corresponds to a height range. In FIG. 6B, the abscissa axis represents the angle, the ordinate axis represents the proportion of white pixels in the region corresponding to different angles in each image region, the proportion of white pixels in the region corresponding to each angle in each image region may be represented by a scatter (e.g., scatter 64) in the coordinate system, the scatters corresponding to the image regions within the same height range may be fitted into a distribution curve (e.g., curve 65) of the proportion of white pixels, and the different curves in the coordinate system may reflect the change of the proportion of white pixels in the region corresponding to different angles in the image region corresponding to the specific height range in the sub-image having defects. Through the curve graph, the preset height range in the longitudinal dimension may be determined intuitively from the different height ranges in the longitudinal dimension. For example, the height range corresponding to the curve with the highest value may be determined as the preset height range in the longitudinal dimension, or the height range corresponding to the curve with the larger average value may be determined as the preset height range in the longitudinal dimension.

In S602, a proportion range of white pixels in the binarized defect-free wafer edge image is determined based on the normal image library.

Herein, the proportion (denoted as W value) of the white pixels in the binarized defect-free wafer edge image is within the proportion range determined in S602, and correspondingly, the proportion of white pixels in the binarized image of a defective wafer edge is not within the proportion range determined in S602. For example, the proportion of white pixels in the binarized defect-free wafer edge image may range from 0 to 15%.

FIG. 6C illustrates a schematic diagram of comparison between an image region having a wafer edge defect and an image region having no wafer edge defect according to a method for detecting a defect according to an embodiment of the present disclosure. The image region 67 has no wafer edge defect, the proportion of the white pixels in the image region 68 is 80.84%, which is not within the proportion range of 0 to 15% of the white pixels in the defect-free wafer edge image, so it can be determined that the image region 68 has a wafer edge defect.

In S603, with respect to each image region to be detected, binarization processing is performed on the image region to be detected to obtain a proportion of white pixels in the image region to be detected subjected to binarization processing; in the case where the proportion of the white pixels is not within the proportion range of the white pixels in the defect-free wafer edge image subjected to binarization processing, it is determined that the sub-image corresponding to the image region to be detected has the wafer edge defect.

In S604, the W value is served as the observation value to determine whether the X sub-images corresponding to the wafer to be detected have the wafer edge defect, and the warning system is used for warning in the case where it is determined that the wafer has the wafer edge defect.

In S605, the W value is served as the observation value to obtain the change trend graph of the W value in the image region to be detected in the measurement image during different process treatment steps, which provides a reference for the risk judgment of wafer edge abnormality.

In some embodiments, the proportion range of white pixels in the binarized defect-free wafer edge image may also be determined based on the abnormal image library.

FIG. 6D illustrates a schematic diagram of a change curve of a proportion of white pixels in an image region to be detected in a sub-image having a defect in a region corresponding to different angles according to a method for detecting a defect according to an embodiment of the present disclosure. Referring to FIG. 6D, the location of the measurement image in the transversal dimension may be represented by the corresponding angle of the image region on the wafer, and the location of the measurement image in the longitudinal dimension may be represented by the height of the measurement image Image regions 1 to 8 are different image regions to be detected in the sub-images having defects, and each image region corresponds to an angle range. In FIG. 6D, the abscissa axis represents the angle, and the ordinate axis represents the proportion of the white pixels in the region corresponding to different angles in each image region. The proportion of the white pixels in the region corresponding to each angle in each image region may be represented by a scatter in the coordinate system. The scatter corresponding to the same image region may be fitted into a distribution curve (such as curve 66) of the proportion of the white pixels, different curves in the coordinate system may reflect the change of the proportion of the white pixels in the region corresponding to different angles in the image region to be detected in different sub-images having defects. The proportion range of white pixels in the binarized image of the defective wafer edge may be determined visually, and then the proportion range of white pixels in the binarized defect-free wafer edge image may be determined. For example, the minimum value of the proportion of the white pixels in each curve may be determined as the proportion threshold, the proportion range of the white pixels in the binarized image of the defective wafer edge may be a range greater than or equal to the proportion threshold, and the proportion range of the white pixels in the binarized defect-free wafer edge image may be a range less than the proportion threshold.

In the embodiments of the present disclosure, in the method, defect detection is performed according to the measurement image including the wafer edge of the wafer to be detected, and in the case where the defect of the wafer edge is detected, abnormality warning is made on the production line of the wafer product, so as to reduce the influence of the edge defect of the wafer product on the yield of the product, and improve the hysteresis of detecting the abnormal condition of the wafer edge of the wafer product by manual observation in the related technology. In addition, according to method, the distribution characteristic of black and white pixels in the measurement image is also taken as the observation value, and the trend graph of the distribution characteristic of black and white pixels is generated as the risk judgment reference information of the wafer edge abnormality, so that the problem that the wafer edge anomaly trend is not observable in the related technology may be improved.

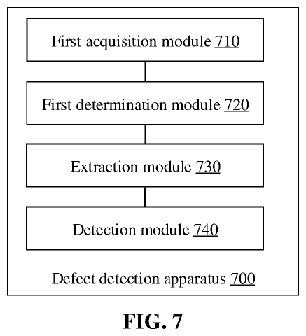

FIG. 7 illustrates a schematic diagram of a composition of an apparatus for detecting a defect according to an embodiment of the present disclosure. As illustrated in FIG. 7, an apparatus 700 for detecting a defect includes a first acquisition module 710, a first determination module 720, an extraction module 730 and a detection module 740.

The first acquisition module 710 is configured to acquire a measurement image including a wafer edge of a wafer to be detected;

The first determination module 720 is configured to determine an image region to be detected in the measurement image;

The extraction module 730 is configured to perform feature extraction on the image region to be detected to obtain a pixel distribution characteristic of the image region to be detected; and

The detection module 740 is configured to perform defect detection on the wafer edge based on the pixel distribution characteristic of the image region to be detected.

In some embodiments, the first determination module is further configured to determine the image region to be detected in the measurement image based on a preset feature.

In some embodiments, the apparatus further includes a second acquisition module and a second determination module. The second acquisition module is configured to acquire a preset abnormal image library, the abnormal image library includes at least one abnormal measurement image, and each abnormal measurement image includes a defect; and the second determination module is configured to determine the preset feature based on an image region where the defect in each abnormal measurement image is located.

In some embodiments, the preset feature includes a preset location range in the longitudinal dimension, and the second determination module is further configured to: determine a location of the image region where the defect in each abnormal measurement image is located in the longitudinal dimension of the each abnormal measurement image; and determine the preset location range in the longitudinal dimension based to a determined location of the image region where the defect in each abnormal measurement image is located.

In some embodiments, the preset feature includes a first preset pixel distribution characteristic in a transversal dimension, and the second determination module is further configured to determine a first image region set based on the image region where the defect in each abnormal measurement image is located, where each image region of the first image region set includes at least one defect; determine a pixel distribution characteristic of each image region of the first image region set in the transversal dimension; and determine the first preset pixel distribution characteristic based on the pixel distribution characteristic of each image region in a transversal dimension.

In some embodiments, the second determination module is further configured to segment each abnormal measurement image in a longitudinal dimension to obtain a second image region set; and select an image region including at least one defect from the second image region set based on the image region where the defect in each abnormal measurement image is located, to obtain the first image region set.

In some embodiments, the first determination module is further configured to segment the measurement image of the wafer edge of the wafer to be detected in the longitudinal dimension to obtain a third image region set; and determine the image region to be detected from the third image region set based on the first preset pixel distribution characteristic.

In some embodiments, the preset feature includes a preset wafer edge feature, the image region to be detected includes an image region including the preset wafer edge feature, and the first determination module is further configured to perform feature recognition on the measurement image to obtain the image region including the preset wafer edge feature.

In some embodiments, the detection module is further configured to determine that the wafer edge has a defect in a case where it is determined that the pixel distribution characteristic of the image region to be detected does not match the second preset pixel distribution characteristic, where the second preset pixel distribution characteristic is used for representing that the image region has no defects.

In some embodiments, the apparatus further includes: a third acquisition module configured to acquire a preset normal image library, where the normal image library includes at least one defect-free wafer edge image; a third determination module configured to determine the pixel distribution characteristic of each defect-free wafer edge image; and a fourth determination module configured to determine the second preset pixel distribution characteristic based on the pixel distribution characteristic of each defect-free wafer edge image.

In some embodiments, the pixel distribution characteristic of the image region to be detected includes a distribution characteristic of black and white pixels in the image region to be detected, and the extraction module is further configured to perform binarization processing on the image region to be detected; and determine the distribution characteristic of the black and white pixels in the image region to be detected subjected to the binarization processing.

In some embodiments, the second preset pixel distribution characteristic includes a preset distribution characteristic of the black and white pixels. The detection module is further configured to determine that the wafer edge has the defect in the case where it is determined that the distribution characteristic of the black and white pixels in the image region to be detected does not match the preset distribution characteristic of the black and white pixels.

In some embodiments, the distribution characteristic of the black and white pixels in the image region to be detected includes a proportion of white pixels in the image region to be detected, and the preset distribution characteristic of the black and white pixels includes a preset threshold of the proportion of the white pixels. The detection module is further configured to determine that the wafer edge has a defect in the case where it is determined that the proportion of white pixels in the image region to be detected is greater than the preset threshold of the proportion of the white pixels.

In some embodiments, a width of the measurement image in the transversal dimension is the same as a perimeter of the wafer to be detected, and the first determination module is further configured to divide the measurement image equally in a transversal dimension to obtain multiple sub-images; and determine the image region to be detected in each of the sub-images.

In some embodiments, the apparatus further includes a warning device configured to generate and transmit warning information in the case where it is determined that the wafer edge has a defect.

In some embodiments, the apparatus further includes a fifth determination module configured to determine a process chamber corresponding to the measurement image; and a stopping module configured to stop operation of a machine in the process chamber in a case where it is determined that the wafer edge has a defect.

In some embodiments, the apparatus further includes: a third acquisition module configured to acquire a time range to be queried and a process chamber in response to a data query operation acting on a wafer edge anomaly trend query interface; a query module configured to query the pixel distribution characteristic of the image region to be detected in each measurement image acquired within the time range and corresponding to the process chamber; and a display module configured to display the pixel distribution characteristic of the image region to be detected in each measurement image in the wafer edge anomaly trend query interface.

The descriptions of the above apparatus embodiments are similar to the descriptions of the above method embodiments, and have similar beneficial effects as the method embodiments. For technical details not disclosed in the apparatus embodiments of the present disclosure, please refer to the descriptions of the method embodiments of the present disclosure.

It should be noted that in the embodiments of the present disclosure, if the above method for detecting a defect is implemented in the form of a software function module and sold or used as an independent product, it may also be stored in a computer-readable storage medium. According to such an understanding, the technical solutions in the embodiments of the present disclosure essentially or the part contributing to the related art may be embodied in the form of a software product stored in a storage medium including several instructions for causing a computer device (which may be a personal computer, a server, a network device, or the like) to perform all or part of the methods described in the embodiments of the present disclosure. The above storage media includes: a USB flash drive, a removable hard disk, a read-only memory (ROM), a magnetic disk, or an optical disc, which may store program code. Thus, the embodiments of the present disclosure are not limited to any specific combination of hardware and software.

Correspondingly, the embodiments of the present disclosure provide a computer device including a memory and a processor, the memory stores a computer program executable on the processor, and the processor implements the operations of the above method when executing the program.

Correspondingly, an embodiment of the present disclosure provides a computer-readable storage medium having stored thereon computer programs that, when executed by a processor, cause the processor to implement the operations of the method.

Correspondingly, the embodiments of the present disclosure provide a computer program product including a non-transitory computer-readable storage medium storing computer programs, the computer programs implement some or all of the steps of the method when it is read and executed by a computer. The computer program product may be specifically implemented by hardware, software, or a combination thereof. In an alternative embodiment, the computer program product is embodied as a computer storage medium, and in another alternative embodiment, the computer program product is embodied as a software product, such as a software development kit (SDK).

It should be noted herein that the descriptions of the above storage medium, computer program product and device embodiment are similar to the descriptions of the above method embodiments, and have similar beneficial effects as the method embodiments. For technical details not disclosed in the storage medium, computer program product and device embodiments of the present disclosure, please refer to the description of the method embodiments of the present disclosure.

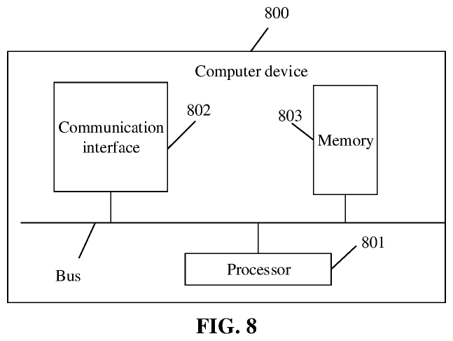

It should be noted that FIG. 8 illustrates a schematic diagram of a hardware entity of a computer device according to an embodiment of the present disclosure. As illustrated in FIG. 8, a hardware entity of the computer device 800 includes a processor 801, a communication interface 802, and a memory 803.

The processor 801 typically controls the overall operation of computer device 800.

The communication interface 802 may enable the computer device to communicate with other terminals or servers through a network.

The memory 803 is configured to store instructions and applications executed by the processor 801, and may also cache data (e.g., image data, audio data, voice communication data, and video communication data) to be processed or already processed by various modules in the processor 801 and the computer device 800, and may be implemented by a flash memory or a random access memory (RAM).

It should be understood that the “one embodiment” or “an embodiment” mentioned throughout the specification means that a specific feature, structure, or characteristics related to the embodiment is included in at least one embodiment of the present disclosure. Therefore, the appearances of “in one embodiment” or “in an embodiment” in various places throughout the specification do not necessarily refer to the same embodiment. Furthermore, these particular features, structures or characteristics may be incorporated in one or more embodiments in any suitable manner. It should be understood that, in various embodiments of the present disclosure, the sequence number of the above processes does not mean the sequence of execution, and the sequence of execution of each process should be determined according to its functions and internal logic, and should not constitute any limitation on the implementation process of the embodiments of the present disclosure. The above embodiments of the present disclosure are numbered only for description, and do not represent advantages or disadvantages of the embodiments.

It should be noted that in this context, the terms “include,” “contain” or any other variant thereof are intended to cover non-exclusive inclusions such that a process, method, article, or apparatus that includes a series of elements includes not only those elements, but also other elements not specifically listed, or elements inherent to such a process, method, article, or apparatus. Without further limitation, the element defined by the statement “including a . . . ” does not rule out there are other identical elements in the process, method, article, or apparatus that includes the element.

In the several embodiments provided in the present disclosure, it should be understood that the disclosed apparatus and method may be implemented in other ways. The device embodiments described above are merely illustrative. For example, the unit division is merely a logical function division, and there may be another division mode in actual implementation, for example, multiple units or components may be combined, or may be integrated into another system, or some features may be ignored or not performed. In addition, the components shown or discussed may be coupled, or directly coupled, or communicatively connected to each other through some interfaces, or indirectly coupled or communicatively connected to a device or unit, which may be electrical, mechanical, or other forms.

The above unit described as the separating component may or may not be physically separated, and the component displayed as the unit may or may not be a physical unit, may be located in one place or distributed across multiple network units. Some or all of these units may be selected according to actual needs to achieve the objective of the solution of this embodiment.

In addition, all the functional units in various embodiments of the present disclosure may be integrated in one processing unit, or each unit may be separately used as one unit, or two or more units may be integrated in one unit. The above integrated units may be implemented in the form of hardware or hardware plus software functional units.

A person of ordinary skill in the art may understand that all or part of the steps of the above method embodiments may be implemented by a program instructing relevant hardware, the above programs may be stored in a computer readable storage medium, and when executed, the programs perform the operations of the above method embodiments. The above storage medium includes various media that may store program codes, such as a removable storage device, a read only memory (ROM), a magnetic disk, or an optical disc.

Alternatively, the integrated units of the embodiments of the present disclosure may be stored in a computer-readable storage medium when they are implemented as software functional modules and sold or used as independent products. According to such an understanding, the technical solutions in the embodiments of the present disclosure essentially or the part contributing to the related art may be embodied in the form of a software product stored in a storage medium including several instructions for causing a computer device (which may be a personal computer, a server, a network device, or the like) to perform all or part of the methods described in the embodiments of the present disclosure. The above storage medium includes medium that may store program code, such as a removable storage device, a ROM, a magnetic disk, an optical disc.

The above descriptions are merely implementations in the embodiments of the present disclosure, but the protection scope of the embodiments of the present disclosure is not limited thereto. Any change or replacement readily figured out by a person skilled in the art within the technical scope disclosed in the embodiments of the present disclosure shall fall within the protection scope of the embodiments of the present disclosure. Therefore, the protection scope of the embodiments of the present disclosure shall be subject to the protection scope of the claims.

### INDUSTRIAL APPLICABILITY

In the embodiments of the present disclosure, firstly, a measurement image including a wafer edge of a wafer to be detected is acquired; secondly, an image region to be detected is determined in the measurement image; and then, feature extraction is performed on the image region to be detected to obtain a pixel distribution characteristic of the image region to be detected; finally, defect detection is performed on the wafer edge based on the pixel distribution characteristic of the image region to be detected. In such a way, the labor cost may be reduced, the missing detection or false detection may be reduced, and the defect at the wafer edge of the wafer to be detected may be discovered in time. Furthermore, since the defect detection of the wafer edge is performed based on the pixel distribution characteristic of the image region to be detected, and the image region to be detected is determined in the measurement image of the wafer edge of the wafer to be detected, and therefore, the efficiency of the defect detection may be effectively improved.

1. A method for detecting a defect, comprising:
acquiring a measurement image comprising a wafer edge of a wafer to be detected;
determining an image region to be detected in the measurement image;
performing feature extraction on the image region to be detected to obtain a pixel distribution characteristic of the image region to be detected; and
performing defect detection on the wafer edge based on the pixel distribution characteristic of the image region to be detected.

2. The method of claim 1, wherein determining the image region to be detected in the measurement image comprises:
determining the image region to be detected in the measurement image based on a preset feature.

3. The method of claim 2, further comprising: before acquiring the measurement image comprising the wafer edge of the wafer to be detected,
acquiring a preset abnormal image library, wherein the preset abnormal image library comprises at least one abnormal measurement image, and each abnormal measurement image comprises a defect; and
determining the preset feature based on an image region where the defect in each abnormal measurement image is located.

4. The method of claim 3, wherein the preset feature comprises a preset location range in a longitudinal dimension, and determining the preset feature based on the image region where the defect in each abnormal measurement image is located comprises:
determining a location of the image region where the defect in each abnormal measurement image is located in the longitudinal dimension of the each abnormal measurement image; and
determining the preset location range in the longitudinal dimension based on a determined location of the image region where the defect in each abnormal measurement image is located.

5. The method of claim 3, wherein the preset feature comprises a first preset pixel distribution characteristic in a transversal dimension, and determining the preset feature based on the image region where the defect in each abnormal measurement image is located comprises:
determining a first image region set based on the image region where the defect in each abnormal measurement image is located, wherein each image region of the first image region set comprises at least one defect;
determining a pixel distribution characteristic of each image region of the first image region set in the transversal dimension; and
determining the first preset pixel distribution characteristic based on the pixel distribution characteristic of each image region in the transversal dimension.

6. The method of claim 5, wherein determining the first image region set based on the image region where the defect in each abnormal measurement image is located comprises:
segmenting each abnormal measurement image in a longitudinal dimension to obtain a second image region set; and
selecting an image region comprising at least one defect from the second image region set based on the image region where the defect in each abnormal measurement image is located, to obtain the first image region set.

7. The method of claim 6, wherein determining the image region to be detected in the measurement image based on the preset feature comprises:
segmenting the measurement image of the wafer edge of the wafer to be detected in the longitudinal dimension to obtain a third image region set; and
determining the image region to be detected from the third image region set based on the first preset pixel distribution characteristic.

8. The method of claim 2, wherein the preset feature comprises a preset wafer edge feature, the image region to be detected comprises an image region comprising the preset wafer edge feature, and determining the image region to be detected in the measurement image based on the preset feature comprises:
performing feature recognition on the measurement image to obtain the image region comprising the preset wafer edge feature.

9. The method of claim 1, wherein performing defect detection on the wafer edge based on the pixel distribution characteristic of the image region to be detected comprises:
determining that the wafer edge has a defect in a case where it is determined that the pixel distribution characteristic of the image region to be detected does not match a second preset pixel distribution characteristic, wherein the second preset pixel distribution characteristic is used for representing that the image region has no defects.

10. The method of claim 9, further comprising:
acquiring a preset normal image library, wherein the preset normal image library comprises at least one defect-free wafer edge image;
determining the pixel distribution characteristic of each defect-free wafer edge image; and
determining the second preset pixel distribution characteristic based on the pixel distribution characteristic of each defect-free wafer edge image.

11. The method of claim 9, wherein the pixel distribution characteristic of the image region to be detected comprises a distribution characteristic of black and white pixels in the image region to be detected, and performing feature extraction on the image region to be detected to obtain the pixel distribution characteristic of the image region to be detected comprises:
performing binarization processing on the image region to be detected; and
determining the distribution characteristic of the black and white pixels in the image region to be detected subjected to the binarization processing.

12. The method of claim 11, wherein the second preset pixel distribution characteristic comprises a preset distribution characteristic of the black and white pixels, and determining that the wafer edge has the defect in the case where it is determined that the pixel distribution characteristic of the image region to be detected does not match the second preset pixel distribution characteristic comprises:
determining that the wafer edge has the defect in the case where it is determined that the distribution characteristic of the black and white pixels in the image region to be detected does not match the preset distribution characteristic of the black and white pixels.

13. The method of claim 12, wherein the distribution characteristic of the black and white pixels in the image region to be detected comprises a proportion of white pixels in the image region to be detected, and the preset distribution characteristic of the black and white pixels comprises a preset threshold of the proportion of the white pixels, and
determining that the wafer edge has a defect in the case where it is determined that the distribution characteristic of the black and white pixels in the image region to be detected does not match the preset distribution characteristic of the black and white pixels comprises:
determining that the wafer edge has a defect in the case where it is determined that the proportion of white pixels in the image region to be detected is greater than the preset threshold of the proportion of the white pixels.

14. The method of claim 1, wherein a width of the measurement image in a transversal dimension is the same as a perimeter of the wafer to be detected, and determining the image region to be detected in the measurement image comprises:
dividing the measurement image equally in a transversal dimension to obtain a plurality of sub-images; and
determining the image region to be detected in each of the sub-images.

15. The method of claim 1, further comprising:
generating and transmitting warning information in a case where it is determined that the wafer edge has a defect.

16. The method of claim 1, further comprising:
determining a process chamber corresponding to the measurement image; and
stopping operation of a machine in the process chamber in a case where it is determined that the wafer edge has a defect.

17. The method claim 1, further comprising:
acquiring a time range to be queried and a process chamber in response to a data query operation acting on a wafer edge anomaly trend query interface;
querying the pixel distribution characteristic of the image region to be detected in each measurement image acquired within the time range and corresponding to the process chamber; and
displaying the pixel distribution characteristic of the image region to be detected in each measurement image in the wafer edge anomaly trend query interface.

18. An apparatus for detecting a defect, comprising:
a memory storing processor-executable instructions; and
a processor configured to execute the processor-executable instructions to perform operations of:
acquiring a measurement image comprising a wafer edge of a wafer to be detected;
determining an image region to be detected in the measurement image;
performing feature extraction on the image region to be detected to obtain a pixel distribution characteristic of the image region to be detected; and
performing defect detection on the wafer edge based on the pixel distribution characteristic of the image region to be detected.

19. The apparatus of claim 18, wherein determining the image region to be detected in the measurement image comprises:
determining the image region to be detected in the measurement image based on a preset feature.

20. A non-transitory computer-readable storage medium storing a computer program that, when executed by a processor, causes the processor to implement operations of:
acquiring a measurement image comprising a wafer edge of a wafer to be detected;
determining an image region to be detected in the measurement image;
performing feature extraction on the image region to be detected to obtain a pixel distribution characteristic of the image region to be detected; and
performing defect detection on the wafer edge based on the pixel distribution characteristic of the image region to be detected.
